(19) United States
(12) Patent Application Publication
(10) Pub. No.: US 2016/0221515 A1
(43) Pub. Date: Aug. 4, 2016

(54) TAIL GATE GAP BARRIER

(71) Applicant: Turnberry Innovations, LLC, Marietta, GA (US)

(72) Inventors: William Burd, Columbus, IN (US); Stephen Burd, Hilton Head, SC (US)

(73) Assignee: Turnberry Innovations, LLC, Marietta, GA (US)

(21) Appl. No.: 15/010,094

(22) Filed: Jan. 29, 2016

Related U.S. Application Data
(60) Provisional application No. 62/109,231, filed on Jan. 29, 2015.

(51) Int. Cl. B60R 13/06; B60J 10/80; B62D 33/027

(52) U.S. Cl. CPC B60R 13/06; B62D 33/0273; B60J 10/80

(57) ABSTRACT

A tailgate gap barrier for engaging a portion of a tailgate of a truck and cover the gap between the bed of the truck and the tailgate is disclosed. The barrier has an elongate body and at least one leg extending substantially perpendicularly from the bottom face of the body.

### CONTINUITY

This application claims the benefit of and priority to U.S. Provisional Application Ser. No. 62/109,231, filed on Jan. 29, 2015, all of which is incorporated herein by reference.

### FIELD OF THE INVENTION

The present invention relates generally to a tailgate gap barrier and, more specifically, the present invention relates to a resilient tailgate gap barrier for use with a pick-up truck.

### BACKGROUND OF THE INVENTION

Pick-up trucks have beds and tailgates that fold down from a vertical position to a horizontal position, essentially extending the length of the bed and permitting access to the bed. When folded down, the rear of the bed of the truck and the tailgate define a gap therebetween extending the width of the bed of the truck. As such, materials that are being hauled can get stuck in the gap and interfere with normal use of the lift gate.

Current systems to solve this problem include placing duct tape over the gap, using adhesive weather stripping to fill the gap, or covering the gap with a planar, flexible plastic strip that adheres to the bed of the truck and bends when the lift gate is closed. Each of these solutions has many issues. For instance, duct tape leaves sticky residue and does not last. Weather stripping breaks and remains in the gap and, essentially, does not last long since it is soft. The flexible plastic strip does not remain adhered to the bed of the truck.

It remains desirable in the art to provide a tailgate gap barrier that addresses the limitations associated with known systems, including but not limited to those limitations discussed above.

### SUMMARY OF THE INVENTION

In accordance with the purposes of this invention, as embodied and broadly described herein, this invention, in one aspect, relates to a tailgate gap barrier for engaging a portion of a tailgate of a truck and cover the gap between the bed of the truck and the tailgate. The barrier comprises an elongate body and at least one leg extending substantially perpendicularly from the bottom face of the body.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1 is a side elevational view of one aspect of a tailgate gap barrier;

FIG. 2 is a partially transparent perspective view of the tailgate gap barrier of FIG. 1;

FIG. 3 is a partial side elevational view of the tailgate gap barrier of FIG. 1 positioned within the gap between the bed of the truck and the tailgate, showing tailgate in the open position;

FIG. 4 is a partial side elevational view of the tailgate gap barrier of FIG. 1 positioned within the gap between the bed of the truck and the tailgate, showing tailgate in the closed position; and

FIG. 5 is a partial perspective view of a truck bed and tailgate with the tailgate gap barrier in place.

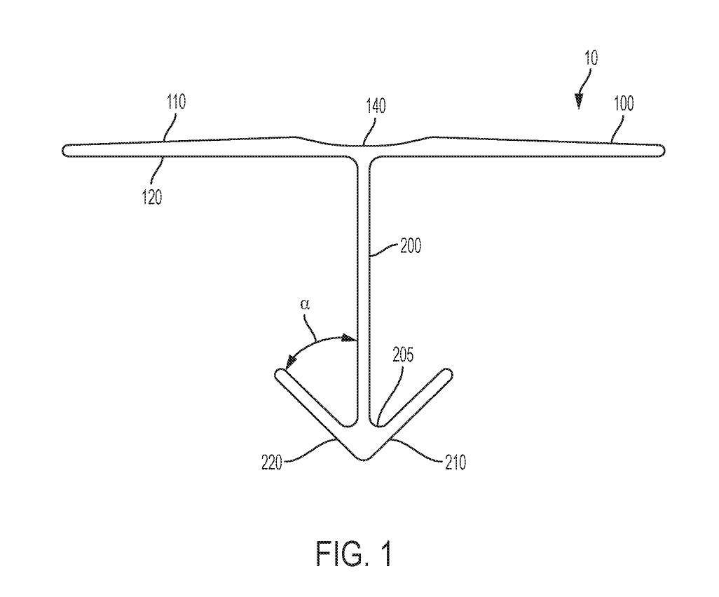

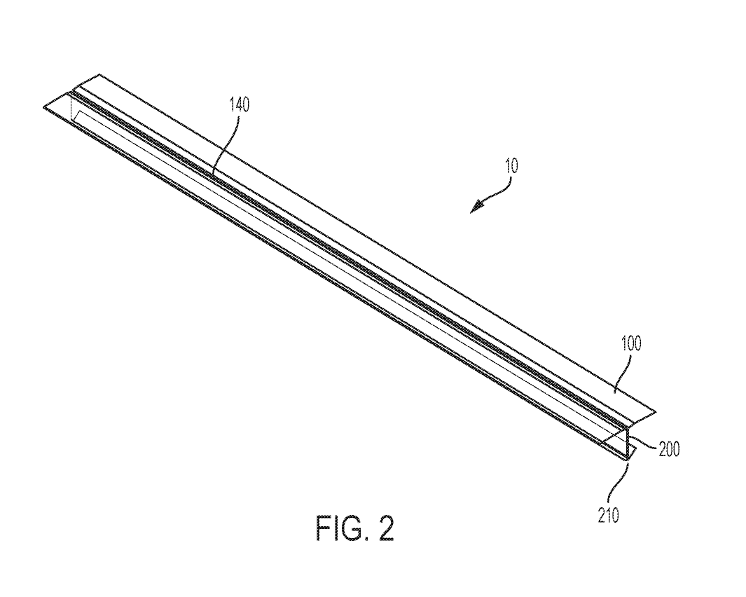

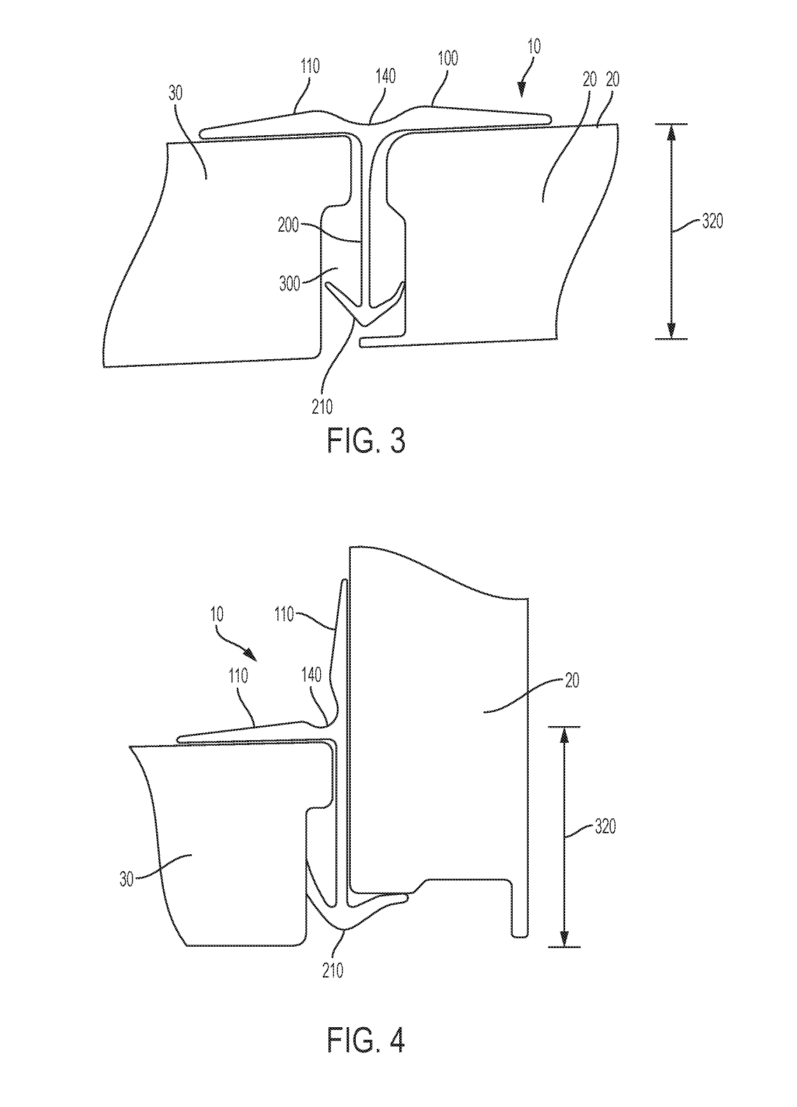

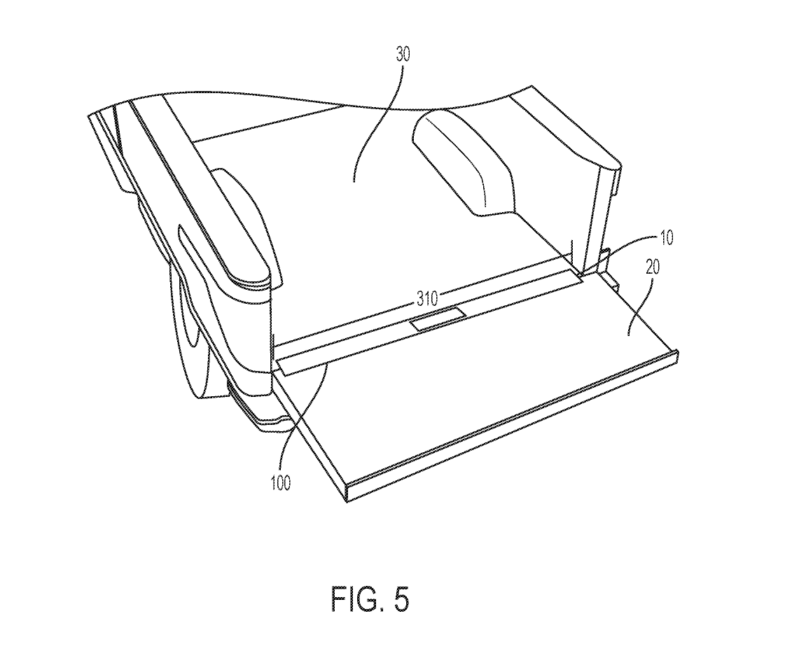

### DESCRIPTION OF THE PREFERRED EMBODIMENTS

The present invention can be understood more readily by reference to the following detailed description, examples, and claims, and their previous and following description. Before the present system, devices, and/or methods are disclosed and described, it is to be understood that this invention is not limited to the specific systems, devices, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known aspect. Those skilled in the relevant art will recognize that many changes can be made to the aspects described, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used herein, the singular forms “a,” “an” and “the” include plural referents unless the context clearly dictates otherwise. Thus, for example, reference to a “plate” includes aspects having two or more plates unless the context clearly indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

Terms used herein, such as “exemplary” or “exemplified,” are not meant to show preference, but rather to explain that the aspect discussed thereafter is merely one example of the aspect presented.

The term “substantially,” as used herein, may be applied to modify any quantitative representation which could permissibly vary without resulting in a change in the basic function to which it is related.

Additionally, descriptive terms, such as “first” or “second” do not necessarily connote plural referents. Alternatively, these terms are merely used to differentiate one object from another or to simply describe a single object. They are not necessarily to be considered in numerical order. For example, a “first object” could just as easily be named “object A” or the like.

Reference will now be made in detail to various embodiments of the present invention, examples of which are illustrated in the accompanying drawings. Wherever possible, the same reference numbers are used throughout the drawings to refer to the same or like parts.

In one aspect, described herein is a tailgate gap barrier 10 for engaging a portion of a tailgate 20 of a truck and cover the gap 300 between the bed 30 of the truck and the tailgate 20. The barrier 10 comprises an elongate body 100 and at least one leg 200 extending substantially perpendicularly from the bottom face 120 of the body 100. In one aspect, the leg 200 has a length at least as long as the gap depth 320 when the tailgate is in the closed position and is positionable therein the gap 300.

In another aspect, the barrier comprises an anchor 210 attached to a distal portion 205 of the leg. In this aspect, the anchor 210 is engageable with a portion of the tailgate to retain the barrier 10 in engagement with the portion of the tailgate 20 such that it substantially covers the gap 300. The leg 200 can be a single leg that spans a portion or substantially the entire length of the body of the barrier. Alternatively, the leg can be a plurality of spaced legs.

In one aspect, the leg 200 is substantially elastic and is able to be biased against a portion of the tailgate and a portion of the truck such that the gap barrier 10 remains taught against the tailgate and the bed 30 of the truck whether the tailgate 20 is in a closed or open position.

In another aspect, the anchor comprises a pair of legs 220 extending at an angle α toward the bottom face 120 of body 100 and wherein the legs 220 are resilient to enable biasing of the gap barrier against the tailgate and the bed of the truck whether the tailgate is in a closed or open position. In one aspect, the angle α is between about 30 degrees and about 55 degrees. In another aspect, the angle is approximately 45 degrees. The anchor can hold the barrier by frictionally engaging the tailgate and the bed of the truck, or it can be long enough to engage an outer portion of the tailgate.

In one exemplified aspect, the length 130 of the body 100 is substantially similar to the gap length 310, such that the gap barrier covers the entire gap 300. In other aspects, the gap body 100 can be slightly shorter than the gap length 310. It is contemplated that the gap body can be substantially monolithic, or two or more adjacent or adjoined pieces.

In still another aspect, the top face 110 of the elongate body 100 defines a central longitudinal recess 140 facilitating bending the body along its length when the tailgate 20 is in a closed position.

While several compounds, mixtures, and materials are contemplated, in one aspect, the barrier 10 comprises a rubber and plastic compound. In one aspect, the material comprises a durometer between about 70 A and 90 A. In another aspect, the material comprises a durometer between about 75 A and about 85 A. In still another aspect, the material comprises a durometer of about 80 A. The material can also be infused or treated with UV protectant to resist cracking due to exposure in the sun.

It is contemplated that the barrier can be manufactured in several ways. For instance, the material can be injection molded or extruded.

In yet another aspect, the top face 110 of the body 100 slopes from a center outwardly along the length of the body 100. This feature reduces the sag and the tendency for material to accumulate in the central portion of the barrier 10. One of the benefits of the reduction is sag is that, when a dolly or other heavy, wheeled, cargo apparatus is rolled over the barrier, the wheels will not tend to sink into the gap and get stuck.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein.

What is claimed is:

1. A tailgate gap barrier for engaging a portion of a tailgate of a truck and cover the gap between the bed of the truck and the tailgate, the gap having a gap width, a gap depth, and a gap length, the tailgate gap comprising:
an elongate body having a top face, a bottom face, and a length;
at least one leg extending substantially perpendicularly from the bottom face, the at least one leg positionable therein the gap;
an anchor attached to a distal portion of the at least one leg, the anchor engageable with a portion of the tailgate to retain the tailgate gap barrier in engagement with the portion of the tailgate of the truck such that it substantially covers the gap.

2. The tailgate gap barrier of claim 1, wherein the leg of the anchor is at least as long as the gap depth when the tailgate is in the closed position.

3. The tailgate gap barrier of claim 1, wherein the at least one leg spans substantially the entire length of the body.

4. The tailgate gap barrier of claim 1, wherein the at least one leg comprises a plurality of legs.

5. The tailgate gap barrier of claim 1, wherein the at least one leg is biased against a portion of the tailgate and a portion of the truck such that the tailgate gap barrier remains taught against the tailgate and the bed of the truck whether the tailgate is in a closed or open position.

6. The tailgate gap barrier of claim 1, wherein the length of the body is substantially similar to the gap length.

7. The tailgate gap barrier of claim 1, wherein the body is substantially monolithic.

8. The tailgate gap barrier of claim 1, wherein the top face of the elongate body defines a central longitudinal recess facilitating bending the body along its length when the tailgate is in a closed position.

9. The tailgate gap barrier of claim 1, wherein the anchor comprises a pair of legs extending at an angle toward the bottom face of body and wherein the legs are resilient to enable biasing of the gap barrier against the tailgate and the bed of the truck whether the tailgate is in a closed or open position.

10. The tailgate gap barrier of claim 9, wherein the angle is between about 30 degrees and about 55 degrees.

11. The tailgate gap barrier of claim 9, wherein the angle is approximately 45 degrees.

12. The tailgate gap barrier of claim 1, wherein the barrier comprises a rubber and plastic compound.

13. The tailgate gap barrier of claim 12, wherein the barrier is formed by extrusion.

14. The tailgate gap barrier of claim 1, wherein the top face of the body slopes from a center outwardly along the length of the body.

15. The tailgate gap barrier of claim 1, further comprises an anti ultra violet additive.
